(19) United States
(12) Patent Application Publication
(10) Pub. No.: US 2026/0336329 A1
(43) Pub. Date: Oct. 29, 2026

(54) WHEEL FOR MOBILITY AND VEHICLE

(71) Applicant: KOREA ADVANCED INSTITUTE OF SCIENCE AND TECHNOLOGY, Daejeon (KR)

(72) Inventors: Dae-Young LEE, Daejeon (KR); DongWook YANG, Daejeon (KR)

(73) Assignee: KOREA ADVANCED INSTITUTE OF SCIENCE AND TECHNOLOGY, Daejeon (KR)

(21) Appl. No.: 19/661,652

(22) Filed: Apr. 28, 2026

(30) Foreign Application Priority Data
Apr. 28, 2025 (KR) 10-2025-0055168

(51) Int. Cl. B60C 7/14; B60B 9/26; B60B 19/00

(52) U.S. Cl. CPC B60C 7/146; B60B 9/26; B60B 19/006; B60B 2900/551

(57) ABSTRACT

A traveling wheel and a traveling apparatus are disclosed. The traveling wheel and the traveling apparatus according to an aspect of the present disclosure include a hub portion connected to a rotation shaft, a rim portion surrounding the hub portion about the rotation shaft, and a plurality of flexible spokes coupling the hub portion and the rim portion and arranged radially about a center of the rotation shaft, wherein the rim portion includes a plurality of segment portions connected in a closed-loop structure.

### CROSS-REFERENCE TO RELATED APPLICATION(S)

This application claims priority to and benefits of Korean Patent Application No. 10-2025-0055168, under 35 U.S. C § 119, filed on Apr. 28, 2025, in the Ministry of Intellectual Property, the contents of which are incorporated herein in its entirety by reference.

### BACKGROUND

### 1. Technical Field

The present disclosure relates to a traveling wheel and a traveling apparatus. More particularly, the present disclosure relates to a traveling wheel and a traveling apparatus capable of traveling on unstructured terrain.

### 2. Description of the Related Art

Rapid advancements in mobile robot and vehicle technologies have driven new research aimed at improving traveling performance in diverse environments.

In particular, stable traveling in complex environments such as urban areas, mountains, deserts, beaches, and extraterrestrial planetary surfaces remains a significant challenge. To ensure mobility in such environments, innovative approaches different from conventional fixed wheels are required.

### SUMMARY

Embodiments of the present disclosure are directed to providing a traveling wheel and a traveling apparatus capable of ensuring traveling performance even on unstructured terrain such as urban and mountainous environments.

A traveling wheel according to an aspect of the present disclosure includes: a hub portion connected to a rotation shaft; a rim portion surrounding the hub portion about the rotation shaft; and a plurality of flexible spokes coupling the hub portion and the rim portion and arranged radially about a center of the rotation shaft, wherein the rim portion includes a plurality of segment portions connected in a closed-loop structure.

The rim portion may further include a plate-shaped flexible connecting member connecting the plurality of segment portions, and the connecting member may form a joint structure between adjacent segment portions.

The segment portions may each include a first segment body disposed on an outer surface of the connecting member.

The segment portions may each further include a second segment body disposed on an inner surface of the connecting member corresponding to the first segment body.

The connecting member may be interposed between the first segment body and the second segment body, and the segment portions may each further include a coupling member coupling the first segment body and the second segment body.

The first segment body may have a rectangular parallelepiped structure, and when adjacent first segment bodies are arranged in a line, side surfaces thereof may be in close contact with each other to provide support.

The second segment body may have a hexahedral structure with an inclined surface, and when bending occurs between adjacent second segment bodies, the inclined surfaces may come into close contact to limit a bending angle between the adjacent second segment bodies.

The plurality of spokes may each have both ends respectively coupled to adjacent segment portions and a central portion connected to the hub portion.

The hub portion may include a plurality of cylindrical support shafts arranged radially about the center of the rotation shaft, and the central portion of each of the plurality of spokes may be wound around and supported by the cylindrical support shafts.

The rim portion may further include an attachment means coupled to an outer surface thereof and configured to attach to a contact surface.

The attachment means may include a magnetic member generating magnetic force.

A traveling apparatus according to another aspect of the present disclosure includes: a body; and a plurality of traveling wheels rotatably mounted to the body, wherein each of the plurality of traveling wheels includes: a hub portion connected to a rotation shaft; a rim portion surrounding the hub portion about the rotation shaft; and a plurality of flexible spokes coupling the hub portion and the rim portion and arranged radially about a center of the rotation shaft, wherein the rim portion includes a plurality of segment portions connected in a closed-loop structure.

The rim portion may further include a plate-shaped flexible connecting member connecting the plurality of segment portions, and the connecting member may form a joint structure between adjacent segment portions.

The segment portions may each include a first segment body disposed on an outer surface of the connecting member.

The segment portions may each further include a second segment body disposed on an inner surface of the connecting member corresponding to the first segment body.

The connecting member may be interposed between the first segment body and the second segment body, and the segment portions may each further include a coupling member coupling the first segment body and the second segment body.

The first segment body may have a rectangular parallelepiped structure, and when adjacent first segment bodies are arranged in a line, side surfaces thereof may be in close contact with each other to provide support.

The second segment body may have a hexahedral structure with an inclined surface, and when bending occurs between adjacent second segment bodies, the inclined surfaces may come into close contact to limit a bending angle between the adjacent second segment bodies.

The plurality of spokes may each have both ends respectively coupled to adjacent segment portions and a central portion connected to the hub portion.

The hub portion may include a plurality of cylindrical support shafts arranged radially about the center of the rotation shaft, and the central portion of each of the plurality of spokes may be wound around and supported by the cylindrical support shafts.

The rim portion may further include an attachment means coupled to an outer surface thereof and configured to attach to a contact surface.

The attachment means may include a magnetic member generating magnetic force.

According to embodiments of the present disclosure, a large ground contact area may be secured even on unstructured terrain, thereby enabling stable traveling.

Moreover, by including a magnetic member, the traveling wheel may climb walls made of magnetic materials.

The traveling wheel may adapt to a contact surface and move even between walls having an angle exceeding 90 degrees.

The traveling wheel may be implemented in a simple structure, thereby enabling easy maintenance and high durability.

### BRIEF DESCRIPTION OF THE DRAWINGS

These and/or other features will become apparent and more readily appreciated from the following description of the embodiments, taken in conjunction with the accompanying drawings in which:

FIG. 1 is an illustration of a traveling apparatus according to an embodiment of the present disclosure;

FIGS. 2 to 4 illustrate a traveling wheel of the traveling apparatus according to an embodiment of the present disclosure;

FIG. 5 illustrates a hub portion of the traveling wheel according to an embodiment of the present disclosure;

FIGS. 6 and 7 illustrate a configuration of a rim portion and a spoke of the traveling wheel according to an embodiment of the present disclosure;

FIG. 8 illustrates a joint structure of the rim portion of the traveling wheel according to an embodiment of the present disclosure;

FIGS. 9 and 10 illustrate a connection structure between the spokes and the hub portion of the traveling wheel according to an embodiment of the present disclosure;

FIGS. 11 and 12 illustrate operation of the rim portion of the traveling wheel according to an embodiment of the present disclosure;

FIG. 13 illustrates operational changes of the traveling wheel according to changes in lengths of the spokes in the traveling wheel according to an embodiment of the present disclosure;

FIGS. 14 to 16 illustrate changes in tension of the spokes according to configurations of the spokes in the traveling wheel according to an embodiment of the present disclosure; and

FIG. 17 is an illustration of a traveling wheel according to another embodiment of the present disclosure.

### DETAILED DESCRIPTION

Terms used in the present application are used only for the purpose of describing particular embodiments and are not intended to limit the present disclosure. Singular expressions include plural expressions unless the context clearly indicates otherwise.

In the present application, when a component is described as “including” another component, it means that the component may further include other components, unless otherwise specifically stated, rather than excluding other components. Further, throughout the specification, the term “on” means positioned above or below a target portion and does not necessarily mean positioned above with reference to a gravitational direction.

Further, the term “coupled” is intended to include not only a case in which respective components are in direct physical contact with each other, but also a case in which another component is interposed between the respective components such that the respective components are in contact with the other component.

Further, terms such as “first,” “second,” and the like may be used to describe various components, but such components should not be limited by these terms. These terms are used only for the purpose of distinguishing one component from another component.

Dimensions and thicknesses of components illustrated in the drawings are arbitrarily shown for convenience of explanation, and thus the present disclosure is not necessarily limited to those illustrated.

Hereinafter, embodiments of a traveling apparatus and a traveling wheel according to the present disclosure will be described in detail with reference to the accompanying drawings. In the following description with reference to the accompanying drawings, the same or corresponding components are denoted by the same reference numerals, and redundant descriptions thereof will be omitted.

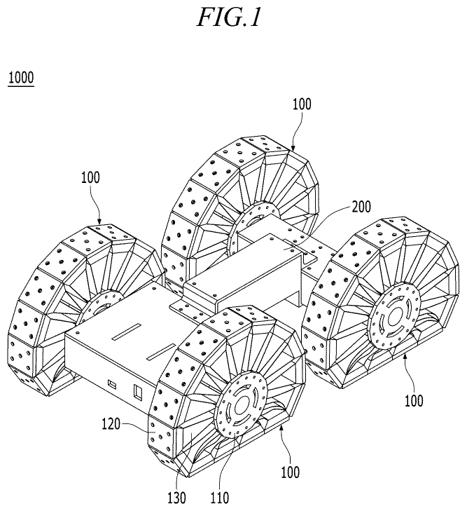

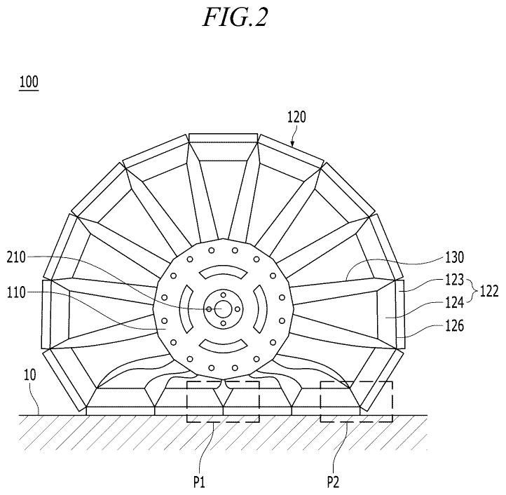

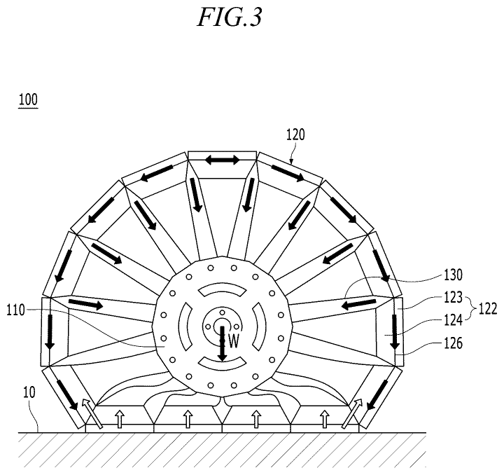

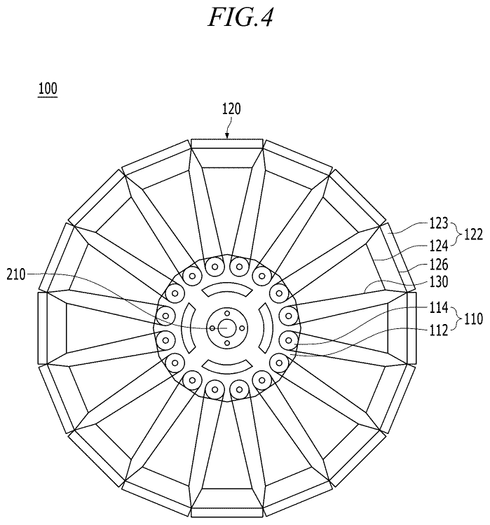

FIG. 1 is an illustration of a traveling apparatus according to an embodiment of the present disclosure, and FIGS. 2 to 4 illustrate a traveling wheel of the traveling apparatus according to an embodiment of the present disclosure. FIGS. 2 and 3 respectively illustrate a shape of the traveling wheel and a distribution of forces when the traveling apparatus according to the present embodiment is subjected to a load, and FIG. 4 illustrates a shape of the traveling wheel when no external force is applied and the traveling wheel is in an expanded state.

Referring to FIG. 1, a traveling apparatus 1000 according to an embodiment of the present disclosure includes a body 200 and a plurality of traveling wheels 100.

The body 200 forms a basic structure of the traveling apparatus 1000. A power mechanism, a rotation shaft, or the like necessary for traveling may be installed in the body 200.

Referring to FIG. 1, the body 200 according to the present embodiment may form an overall external shape of the traveling apparatus 1000. Rotation shafts (not shown), which rotatably support the traveling wheels 100 to be described later, may be installed in parallel at front and rear portions of the body 200. Driving components such as, for example, a motor and a battery for providing driving force to the traveling wheels 100 may be installed inside the body 200. In such a case, the rotation shafts may be connected to the motor to be rotated, or alternatively, the rotation shafts may be installed in a state of being rotatably supported by the body 200 without being directly driven.

The traveling wheels 100 is configured to support a load of the body 200 and rotate to move the traveling apparatus 1000. A plurality of the traveling wheels 100 according to the present embodiment may be rotatably mounted to the body 200.

Referring to FIG. 1, a pair of the traveling wheels 100 may be installed at each of front and rear portions of the body 200.

Referring to FIGS. 1 to 4, the traveling wheel 100 according to an embodiment of the present disclosure includes a hub portion 110, a rim portion 120, and a plurality of spokes 130.

The hub portion 110 is connected to a rotation shaft 210 to allow the traveling wheel 100 to rotate. The hub portion 110 may be coupled to the rotation shaft 210 to rotate together with the rotation shaft 210 or may be rotatably connected to the rotation shaft 210.

Referring to FIGS. 1 to 4, the hub portion 110 according to the present embodiment may be disposed at a center of the traveling wheel 100 and may have a structure connected to the rotation shaft 210.

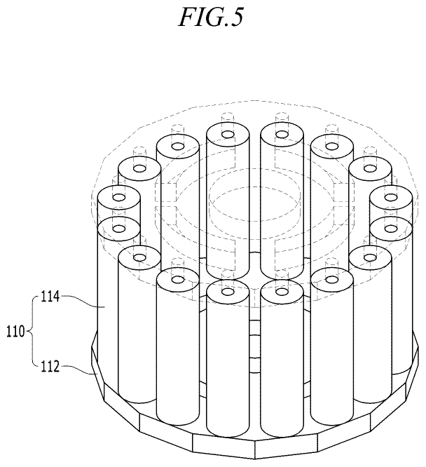

FIG. 5 illustrates the hub portion 110 of the traveling wheel 100 according to an embodiment of the present disclosure.

Referring to FIGS. 4 and 5, the hub portion 110 according to the present embodiment may include a plurality of cylindrical support shafts 114 arranged radially about the center of the rotation shaft 210. For example, the hub portion 110 according to the present embodiment may include a disk-shaped rotating plate 112, and the rotation shaft 210 may be coupled to a center of the rotating plate 112. In addition, the plurality of cylindrical support shafts 114 may be installed to stand along a circumference of the rotating plate 112.

The rim portion 120 is disposed at an outermost side of the traveling wheel 100 and contacts a surface 10 on which the traveling wheel 100 is supported. The rim portion 120 according to the present embodiment is arranged to surround the hub portion 110 about the rotation shaft 210 and includes a plurality of segment portions 122 connected in a closed-loop structure.

Referring to FIGS. 1 to 4, the rim portion 120 according to the present embodiment may have a ring structure in which the plurality of segment portions 122 are continuously connected in a single row to form a closed loop.

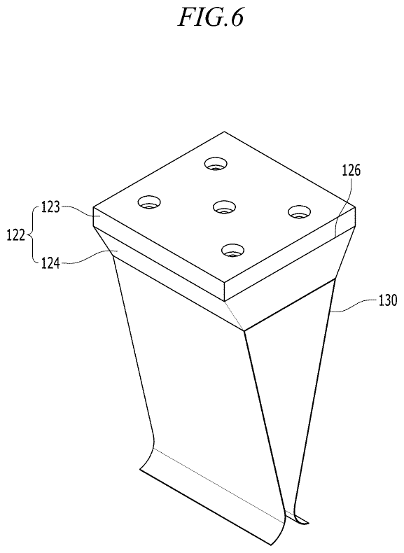

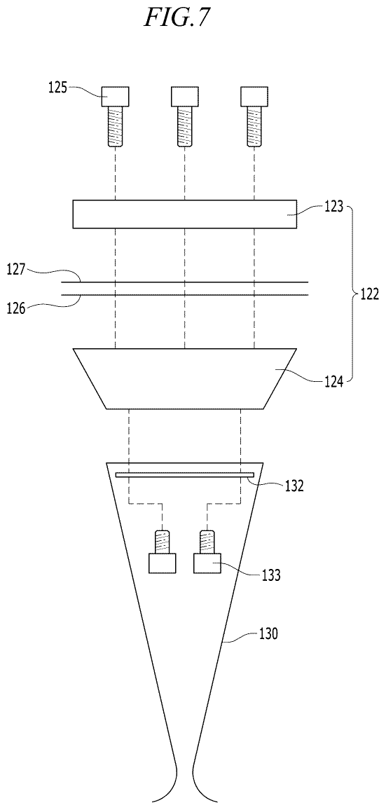

FIGS. 6 and 7 illustrate a configuration of the rim portion 120 and the spokes 130 of the traveling wheel 100 according to an embodiment of the present disclosure.

Referring to FIGS. 6 and 7, the rim portion 120 according to the present embodiment may further include a plate-shaped flexible connecting member 126 connecting the plurality of segment portions 122. The connecting member 126 may include various flexible materials capable of bending. For example, the connecting member 126 may include flexible materials such as, for example, fibers and elastomers.

Each of the plurality of segment portions 122 may include a first segment body 123 disposed on an outer surface of the connecting member 126. Moreover, each of the segment portions 122 may further include a second segment body 124 disposed on an inner surface of the connecting member 126 corresponding to the first segment body 123. For example, with the connecting member 126 interposed therebetween, the first segment body 123 and the second segment body 124 having the same width in a lengthwise direction of the connecting member 126 may be disposed to face each other.

Accordingly, the connecting member 126 may be interposed between the first segment body 123 and the second segment body 124, and the segment portion 122 coupled to the connecting member 126 may be formed by coupling the first segment body 123 and the second segment body 124. In such a case, each of the segment portions 122 may further include a coupling member 125, such as a bolt or a screw, configured to couple the first segment body 123 and the second segment body 124. In addition, an adhesive layer 127 may be further provided over the connecting member 126 to enhance bonding strength with the first segment body 123 and/or the second segment body 124.

For example, the connecting member 126 according to the present embodiment may have a band shape in which a plate-shaped member extends longitudinally and opposite ends thereof are connected to form a loop structure. In such a case, the segment portions 122 coupled to the connecting member 126 may be formed by coupling the first segment body 123 and the second segment body 124 with the connecting member 126 interposed therebetween. In particular, the segment portions 122 may be continuously formed along the band-shaped connecting member 126 to thereby form a loop structure in which the plurality of segment portions 122 are continuously connected.

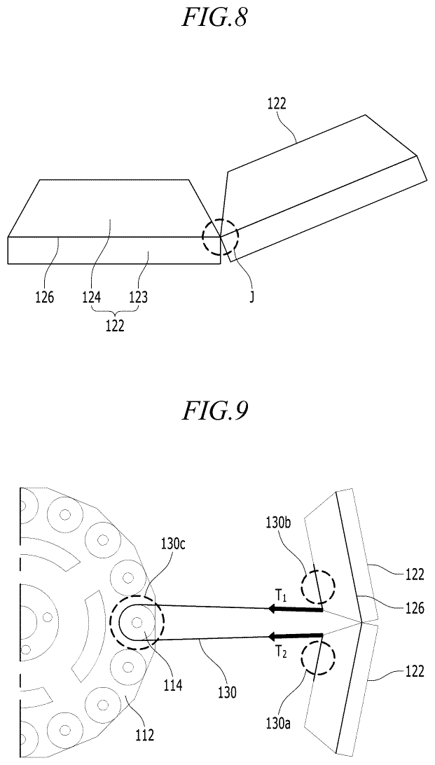

FIG. 8 illustrates a joint structure of the rim portion 120 of the traveling wheel 100 according to an embodiment of the present disclosure.

Referring to FIG. 8, since the connecting member 126 connects the plurality of segment portions 122 and is formed of a flexible material, the connecting member 126 may form a bendable joint structure J between adjacent segment portions 122. For example, the first segment body 123 and the second segment body 124 may have rigid structures made of a material such as metal, while the connecting member 126 is formed of a flexible material capable of bending, such that the connecting member 126 connecting adjacent segment portions 122 may function as a hinge.

The spokes 130 couple the hub portion 110 and the rim portion 120. A plurality of the spokes 130 may be provided, and the plurality of spokes 130 may be arranged radially about the center of the rotation shaft 210. In such a case, the spokes 130 may include various flexible materials capable of bending. For example, the spokes 130 may include various flexible materials such as, for example, fibers and elastomers.

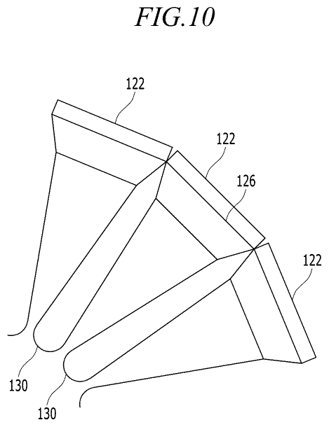

FIGS. 9 and 10 illustrate a connection structure between the spokes 130 and the hub portion 110 of the traveling wheel 100 according to an embodiment of the present disclosure.

Referring to FIGS. 9 and 10, each of the spokes 130 according to the present embodiment may have a band shape extending longitudinally, and both ends 130a and 130 b thereof may be respectively coupled to adjacent segment portions 122. In such a case, a central portion 130c of the spoke 130 may be connected to the hub portion 110.

Referring to FIG. 7, the spoke 130 according to the present embodiment may be coupled to the segment portion 122 by a fixing plate 132 coupled to the segment portion 122. For example, the spoke 130 may be interposed between the second segment body 124 and the fixing plate 132, and the second segment body 124 and the fixing plate 132 may be coupled to each other by a fastening member such as a bolt 133 or a screw.

Referring to FIGS. 4 and 9, in the present embodiment, the central portion 130c of the spoke 130 may be wound around and supported by the cylindrical support shaft 114. For example, the spoke 130 may have a U-shaped band configuration in which both ends 130a and 130b are respectively coupled to adjacent segment portions 122, and the central portion 130c is hooked onto and supported by the cylindrical support shaft 114 of the hub portion 110. Accordingly, the spoke 130 according to the present embodiment may be easily coupled by being hooked onto the cylindrical support shaft 114 of the hub portion 110.

Further, when tension is generated in the spoke 130 according to the present embodiment, since the spoke 130 is supported by being hooked onto the cylindrical support shaft 114, equal magnitudes of tension may be applied to adjacent segment portions 122 coupled to the spoke 130 (for example, T₁=T₂ in FIG. 9). Accordingly, moments generated by the tension transmitted to the adjacent segment portions 122 may cancel each other, such that the adjacent segment portions 122 may maintain a stable state.

Hereinafter, operation of the traveling wheel 100 described above will be described.

Referring to FIGS. 2 and 3, when the traveling wheel 100 according to the present embodiment is subjected to a load of the traveling apparatus 1000, portions of the rim portion 120 of the traveling wheel 100 that contact the ground 10 may be arranged in a straight line by the load. For example, the segment portions 122 disposed at a lower portion of the rim portion 120 of the traveling wheel 100 may be arranged linearly and may be in close contact with the ground. In such a case, the spokes 130 connected to the segment portions 122 arranged linearly on the ground are formed to have a relatively short distance from the hub portion 110 and thus may be in a loosened state. Accordingly, forces such as tension from the spokes 130 may not be applied to the segment portions 122 disposed on the ground, and the segment portions 122 disposed on the ground may be in close contact with the ground due to their own weight (see P1 of FIG. 2).

The segment portions 122 other than those arranged in a straight line may form an arch structure about the hub portion 110. In such a case, the segment portions 122 disposed at both ends of the arch structure may be subjected to a force that tends to increase a span of the arch due to loads applied by segment portions 122 positioned thereabove, such that a structure in which the segment portions 122 are pulled by the spokes 130 connected to the hub portion 110 may be formed. Accordingly, the segment portions 122 disposed at both ends of the arch structure may be supported while forming a predetermined angle with respect to the segment portions 122 arranged in a straight line, by tension of the spokes 130 (see P2 of FIG. 2).

When the plurality of segment portions 122 form the arch structure, the hub portion 110 may be supported in a suspended manner by the plurality of segment portions 122 via the spokes 130 connected to the segment portions 122. Accordingly, the load of the traveling apparatus 1000 applied to the hub portion 110 may be evenly distributed and supported by the plurality of segment portions 122 forming the arch structure.

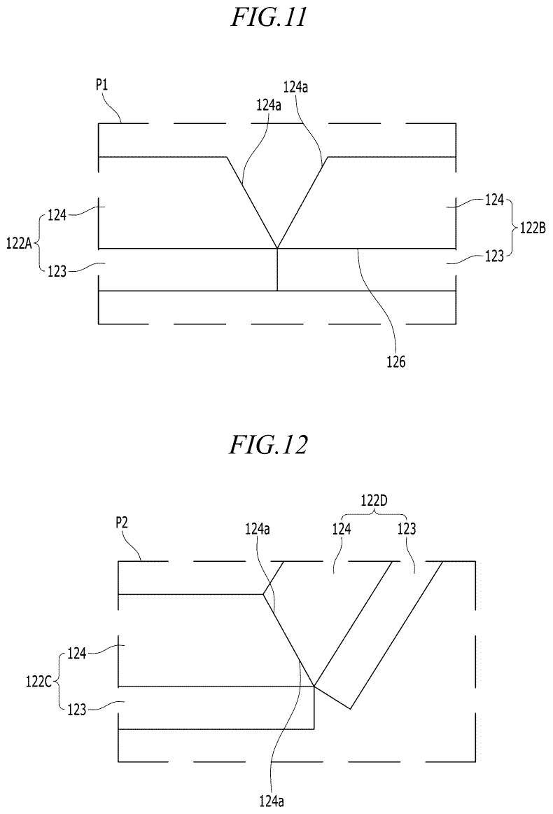

FIGS. 11 and 12 illustrate operation of the rim portion 120 of the traveling wheel 100 according to an embodiment of the present disclosure. FIG. 11 illustrates P1 of FIG. 2 in detail, and FIG. 12 illustrates P2 of FIG. 2 in detail.

Referring to FIGS. 2, 3, and 11, when the traveling wheel 100 according to the present embodiment is subjected to a load of the traveling apparatus 1000, portions of the rim portion 120 of the traveling wheel 100 that contact the ground 10 may be arranged in a straight line by the load. In such a case, in the rim portion 120 according to the present embodiment, the first segment body 123 may have a rectangular parallelepiped structure. Accordingly, when adjacent segment portions 122A and 122B are arranged in a line, adjacent first segment bodies 123 may be supported with side surfaces of the rectangular parallelepiped structure being in close contact with each other. Therefore, since the portions of the rim portion 120 that contact the ground 10 are maintained in a linearly arranged state, a sufficient contact area between the rim portion 120 and the ground 10 may be secured. That is, deformation in which the portions of the rim portion 120 contacting the ground 10 become concave toward an inner side of the rim portion 120 (toward the hub portion 110) and thus reduce the contact area between the rim portion 120 and the ground 10 may be prevented.

Referring to FIGS. 2, 3, and 12, in the rim portion 120 according to the present embodiment, the second segment body 124 may have a hexahedral structure including an inclined surface 124a. For example, inclined surfaces 124a may be formed on opposing side surfaces of adjacent second segment bodies 124, and the inclined surfaces 124a may be formed such that the hexahedral structure becomes narrower toward an inner side of the rim portion 120 (toward the hub portion 110). Accordingly, when bending occurs between adjacent segment portions 122C and 122D, adjacent second segment bodies 124 may come into close contact with each other via the inclined surfaces 124a to thereby limit a bending angle between the adjacent second segment bodies 124. For example, when the segment portions 122 disposed at both ends of an arch structure form a structure supported at a predetermined angle with respect to the segment portions 122 arranged in a straight line, the inclined surfaces 124a of the second segment bodies 124 may come into close contact with each other to limit a bending angle between the adjacent segment portions 122C and 122D.

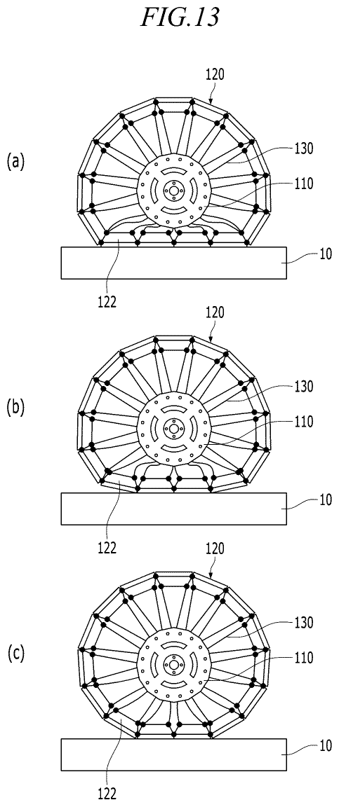

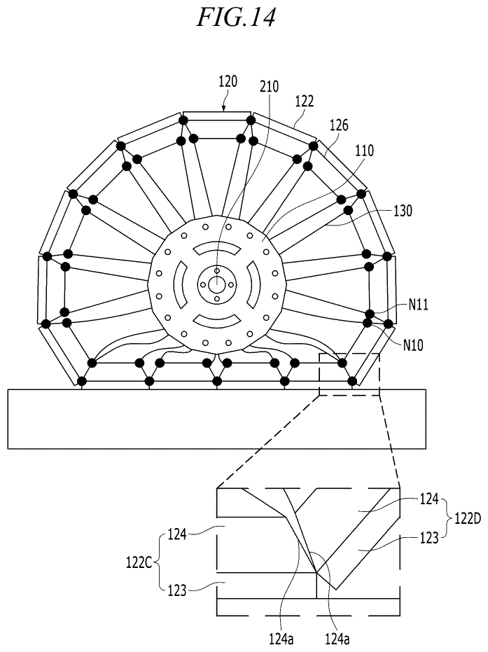

FIG. 13 illustrates operational changes of the traveling wheel 100 according to changes in lengths of the spokes 130 in the traveling wheel 100 according to an embodiment of the present disclosure.

In FIG. 13, the lengths of the spokes 130 are progressively set to be shorter from (a) to (c).

Referring to FIG. 13, in the traveling wheel 100 according to the present embodiment described above, as the lengths of the spokes 130 are set to be shorter, portions of the rim portion 120 of the traveling wheel 100 that contact the ground 10 may decrease. That is, as the lengths of the spokes 130 are set to be shorter, the number of segment portions 122 of the rim portion 120 that are in close contact with the ground may decrease. Accordingly, a contact area between the rim portion 120 of the traveling wheel 100 and the ground may be adjusted by setting the lengths of the spokes 130.

FIGS. 14 to 16 illustrate changes in tension of the spokes 130 according to configurations of the spokes 130 in the traveling wheel 100 according to an embodiment of the present disclosure.

Referring to FIG. 14, when a segment portion 122D disposed at an end of an arch structure forms a structure in which the segment portion 122D is adjacent to and supported at a predetermined angle with respect to segment portions 122C arranged in a straight line, lengths of the spokes 130 may be set such that inclined surfaces 124a of second segment bodies 124 disposed between adjacent segment portions 122C and 122D do not come into contact with each other.

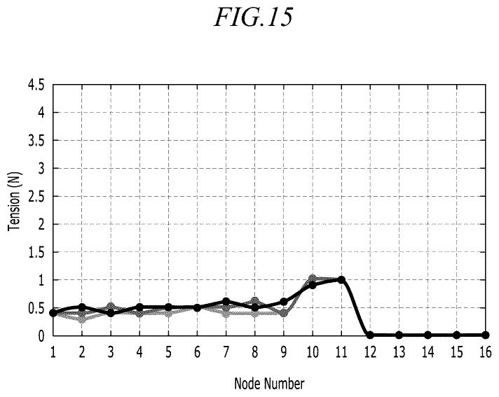

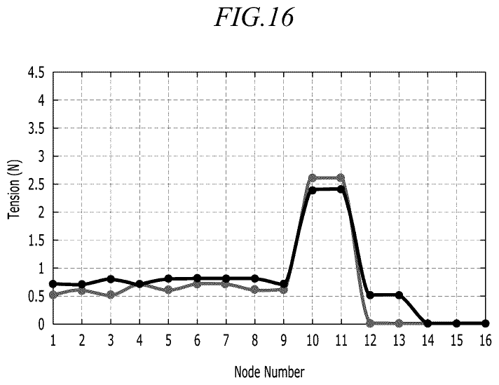

Referring to FIGS. 15 and 16, it may be seen that tension of the spoke 130 connected to the segment portion 122D disposed at the end of the arch structure is formed differently depending on whether the inclined surfaces 124a between adjacent segment portions 122C and 122D are in close contact with each other.

FIG. 15 illustrates tension generated in the spoke 130 connected to the segment portion 122D disposed at the end of the arch structure when the inclined surfaces 124a between adjacent segment portions 122C and 122D are not in close contact with each other (e.g., tension of the spoke 130 at node numbers 10 (N10) or 11 (N11)).

FIG. 16 illustrates tension generated in the spoke 130 connected to the segment portion 122D disposed at the end of the arch structure when the inclined surfaces 124a between adjacent segment portions 122C and 122D are in close contact with each other (e.g., tension of the spoke 130 at node numbers 10 (N10) or 11 (N11)).

By comparing FIGS. 15 and 16, it may be confirmed that when the lengths of the spokes 130 are set such that the inclined surfaces 124a of the second segment bodies 124 between adjacent segment portions 122C and 122D do not come into close contact with each other, tension applied to the spoke 130 connected to the segment portion 122D disposed at the end of the arch structure may be reduced.

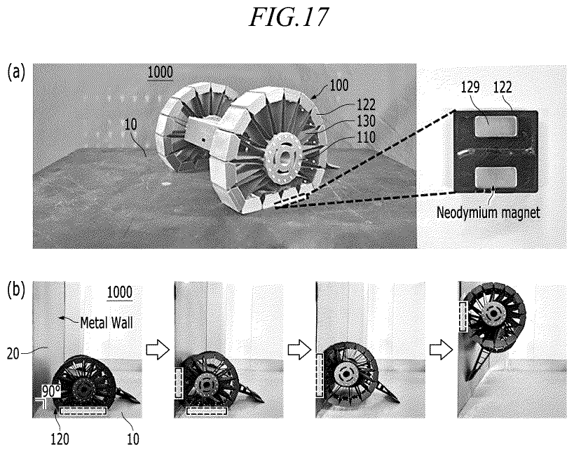

FIG. 17 is an illustration of a traveling wheel 100 according to another embodiment of the present disclosure.

Referring to FIG. 17, in the traveling wheel 100 according to the present embodiment, the rim portion 120 may include an attachment means 129 coupled to an outer surface thereof and configured to attach to a contact surface. Accordingly, the traveling wheel 100 may be brought into close contact with a vertical surface 20 such as a wall or an inclined surface, rather than the ground 10, by using the attachment means 129 of the rim portion 120. The attachment means 129 may include a magnetic member such as a magnet configured to generate a magnetic force, such that the rim portion 120 may be magnetically attached to a metal plate such as an iron plate.

In such a case, by using an attachment force generated by the attachment means 129, some of the segment portions 122 of the rim portion 120 of the traveling wheel 100 may be arranged in a straight line and may be in close contact with the contact surface. In addition, segment portions 122 other than those arranged in a straight line may form an arch structure about the hub portion 110.

Accordingly, the traveling wheel 100 according to the present embodiment may include a magnetic member to climb a wall made of a magnetic material. Further, the traveling wheel 100 may move even between walls having an angle exceeding 90 degrees by using a characteristic of adapting to a contact surface.

Although certain embodiments of the present disclosure have been described above, those of ordinary skill in the art will appreciate that the present disclosure may be variously modified and changed by adding, changing, deleting, or substituting components without departing from the spirit and scope of the present disclosure as defined in the appended claims, and such modifications and changes are also intended to fall within the scope of the present disclosure.

What is claimed is:

1. A traveling wheel, comprising:
a hub portion connected to a rotation shaft;
a rim portion surrounding the hub portion about the rotation shaft; and
a plurality of flexible spokes coupling the hub portion and the rim portion and arranged radially about a center of the rotation shaft,
wherein the rim portion includes a plurality of segment portions connected in a closed-loop structure.

2. The traveling wheel of claim 1, wherein the rim portion further includes a plate-shaped flexible connecting member connecting the plurality of segment portions, and
wherein the connecting member forms a joint structure between adjacent segment portions.

3. The traveling wheel of claim 2, wherein each of the plurality of segment portions includes a first segment body disposed on an outer surface of the connecting member.

4. The traveling wheel of claim 3, wherein each of the plurality of segment portions further includes a second segment body disposed on an inner surface of the connecting member corresponding to the first segment body.

5. The traveling wheel of claim 4, wherein the connecting member is interposed between the first segment body and the second segment body, and
wherein each of the plurality of segment portions further includes a coupling member coupling the first segment body and the second segment body.

6. The traveling wheel of claim 4, wherein the first segment body has a rectangular parallelepiped structure, and
wherein, when adjacent first segment bodies are arranged in a line, side surfaces of the adjacent first segment bodies are in close contact with each other to provide support.

7. The traveling wheel of claim 4, wherein the second segment body has a hexahedral structure including an inclined surface, and
wherein, when bending occurs between adjacent second segment bodies, the inclined surfaces are in close contact with each other to limit a bending angle between the adjacent second segment bodies.

8. The traveling wheel of claim 2, wherein each of the plurality of spokes has both ends respectively coupled to adjacent segment portions and a central portion connected to the hub portion.

9. The traveling wheel of claim 8, wherein the hub portion includes a plurality of cylindrical support shafts arranged radially about the center of the rotation shaft, and
wherein the central portion of each of the plurality of spokes is wound around and supported by the plurality of cylindrical support shafts.

10. The traveling wheel of claim 1, wherein the rim portion further includes an attachment means coupled to an outer surface thereof and configured to attach to a contact surface.

11. The traveling wheel of claim 10, wherein the attachment means includes a magnetic member configured to generate a magnetic force.

12. A traveling apparatus, comprising:
a body; and
a plurality of traveling wheels rotatably mounted to the body,
wherein each of the plurality of traveling wheels comprises:
a hub portion connected to a rotation shaft;
a rim portion surrounding the hub portion about the rotation shaft; and
a plurality of flexible spokes coupling the hub portion and the rim portion and arranged radially about a center of the rotation shaft,
wherein the rim portion includes a plurality of segment portions connected in a closed-loop structure.

13. The traveling apparatus of claim 12, wherein the rim portion further includes a plate-shaped flexible connecting member connecting the plurality of segment portions, and
wherein the connecting member forms a joint structure between adjacent segment portions.

14. The traveling apparatus of claim 13, wherein each of the plurality of segment portions includes a first segment body disposed on an outer surface of the connecting member.

15. The traveling apparatus of claim 14, wherein each of the plurality of segment portions further includes a second segment body disposed on an inner surface of the connecting member corresponding to the first segment body.

16. The traveling apparatus of claim 15, wherein the first segment body has a rectangular parallelepiped structure, and
wherein, when adjacent first segment bodies are arranged in a line, side surfaces of the adjacent first segment bodies are in close contact with each other to provide support.

17. The traveling apparatus of claim 15, wherein the second segment body has a hexahedral structure including an inclined surface, and
wherein, when bending occurs between adjacent second segment bodies, the inclined surfaces are in close contact with each other to limit a bending angle between the adjacent second segment bodies.

18. The traveling apparatus of claim 13, wherein each of the plurality of spokes has both ends respectively coupled to adjacent segment portions and a central portion connected to the hub portion.

19. The traveling apparatus of claim 18, wherein the hub portion includes a plurality of cylindrical support shafts arranged radially about the center of the rotation shaft, and
wherein the central portion of each of the plurality of spokes is wound around and supported by the plurality of cylindrical support shafts.

20. The traveling apparatus of claim 12, wherein the rim portion further includes an attachment means coupled to an outer surface thereof and configured to attach to a contact surface.
